(19) United States
(12) Patent Application Publication
(10) Pub. No.: US 2022/0048453 A1
(43) Pub. Date: Feb. 17, 2022

(54) FRONT BUMPER ASSEMBLY FOR MOUNTING A SEAT AND BALLAST MEANS AND ADD-ON STRUCTURE IN VEHICLE

(71) Applicant: MAHINDRA & MAHINDRA LIMITED, Mohali (IN)

(72) Inventors: Avinash Tighare, Mohali (IN); Vikas Singh, Mohali (IN)

(21) Appl. No.: 17/275,357

(22) PCT Filed: Sep. 12, 2019
(86) PCT No.: PCT/IN2019/050665

§ 371 Date: Mar. 11, 2021

(30) Foreign Application Priority Data
Sep. 12, 2018 (IN) 201811034459

(51) Int. Cl. B60R 19/18; B62D 49/08; B60R 19/24

(52) U.S. Cl. CPC B60R 19/18; B60R 2019/1806; B60R 19/24; B62D 49/085

(57) ABSTRACT

Front bumper assembly 200 for mounting a seat and ballast means and add-on structure in vehicle is provided. Front bumper assembly 200 includes a bumper frame 202, a mounting member 204 and a plurality of reinforcement members 206. The bumper frame 202 includes a base frame 202B and a plurality of legs 202L. The front bumper assembly 200 is removably connected to a vehicular structure C at a first position in which each leg 202L of the bumper frame 202 is horizontally connected to the vehicular structure C, and a second position in which each leg 202L of the bumper frame 202 is vertically connected to the vehicular structure C. The front bumper assembly 200 is adapted to removably receive at least one of an operator's seat S, a ballast means and an add-on structure when the front bumper assembly 200 is in the second position.

### CROSS REFERENCE TO RELATED APPLICATION

This application is based on and derives the benefit of Indian Application 201811034459 filed on 12 Sep. 2018, the contents of which are incorporated herein by reference.

### TECHNICAL FIELD

The embodiments herein relate to a front bumper assembly for a vehicle, which is removably connected to a vehicular structure at at least one of a first position and a second position.

### BACKGROUND

Vehicles such as tractors or other similar vehicles are primarily used in agricultural field operations. Usually, agricultural implements are attached to a front-end or rear-end of the vehicle depending on the type of vehicle configuration and the type of field operation that is to be carried out in the fields. Agricultural field operations require the vehicle to be operated in the reverse direction, and hence the operator must turn back frequently during the reverse operation of the vehicle as the seating arrangement provides only front visibility to the operator and the implement is being attached at rear-end of the vehicle. The rear visibility of the operator is limited and frequent turning of the operator during reverse operation of the vehicle in fields requires more effort of the operator which in turn leads to operator's fatigue resulting in reduced agricultural productivity. To eliminate the aforementioned drawbacks, agricultural implements can be attached to both front-end and rear-end of the vehicle which in turn would require corresponding mechanisms to be installed at both ends of the vehicle to operate the implements being attached at the front-end and the rear end of the vehicle. However, attaching agricultural implements and mechanisms for operating the agricultural implements at both ends of the vehicle incurs high cost, increases an overall weight of the vehicle and increases an overall length of the vehicle.

When attaching the agricultural implements to the front end or the rear end of the vehicle, the weight at one end of the vehicle is larger than the weight at the other end of the vehicle which causes corresponding wheels (front wheels or rear wheels) of the vehicle to float slightly from the ground surface during lifting of the agricultural implement and/or operation of the vehicle in fields thereby de-stabilizing the vehicle. Therefore, there is a requirement to add weight to the front end or the rear end of the vehicle which would require a ballast mass holding arrangement to be provided at corresponding end of the vehicle depending on the type of vehicle configuration and the attachment of agricultural implements to the vehicle. Providing ballast mass holding arrangement at the front-end or the rear end of the vehicle for adding weight to the front end or the rear end of the vehicle will increase the overall length of the vehicle which in turn restricts the maneuverability of the vehicle. Therefore, the requirement of providing the ballast mass holding arrangement for adding ballast to the front end or the rear end of the vehicle is difficult and is one of the challenges posed to the original equipment manufacturers (OEM'S).

Therefore, there exists a need for a front bumper assembly for a vehicle, which is removably connected to a vehicular structure at at least one of a first position and a second position. Further, there exists a need for a front bumper assembly for a vehicle, which obviates the aforementioned drawbacks.

### Objects

The principal object of an embodiment of this invention is to provide a front bumper assembly for a vehicle, which is removably connected to a vehicular structure at at least one of a first position and a second position.

Another object of an embodiment of this invention is to provide a front bumper assembly for a vehicle, which removably receives an operator's seat.

Another object of an embodiment of this invention is to provide a front bumper assembly for a vehicle, which enables mounting of an add-on structure thereon, to accommodate any of tools and auxiliary equipment's in the add-on structure, where the add-on structure is a storage compartment.

Another object of an embodiment of this invention is to provide a front bumper assembly for a vehicle, which enables mounting of an add-on structure thereon, to mount at least one of agricultural devices, machines, spare wheels, mechanical devices such as pumps and generator, onto the front bumper assembly, where the add-on structure is a mounting structure.

Another object of an embodiment of this invention is to provide a front bumper assembly for a vehicle, which enables mounting of a ballast means thereon.

These and other objects of the embodiments herein will be better appreciated and understood when considered in conjunction with the following description and the accompanying drawings. It should be understood, however, that the following descriptions, while indicating embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments of the invention are illustrated in the accompanying drawings, throughout which like reference letters indicate corresponding parts in the various figures. The embodiments herein will be better understood from the following description with reference to the drawings, in which:

FIG. 1 depicts a perspective view of a front bumper assembly for a vehicle, according to an embodiment of the invention as disclosed herein;

FIG. 2 depicts another perspective view of the front bumper assembly, according to an embodiment of the invention as disclosed herein;

FIG. 3 depicts a perspective view of the front bumper assembly is removably connected to a vehicular structure at a first position, where an operator's seat is being provided at a rear-end of the vehicle, according to an embodiment of the invention as disclosed herein;

FIG. 4 depicts a perspective view of the front bumper assembly is removably connected to the vehicular structure at a second position, where the front bumper assembly is adapted to removably receive the operator's seat, according to an embodiment of the invention as disclosed herein;

FIG. 5 depicts a schematic view of the vehicle, where the front bumper assembly is removably connected to the vehicular structure at the first position, and the vehicle is to be operated from a first driving position, according to an embodiment of the invention as disclosed herein;

FIG. 6 depicts a schematic view of the vehicle, where the front bumper assembly is being removably connected to the vehicular structure at the second position, and the vehicle is to be operated from a second driving position, according to an embodiment of the invention as disclosed herein; and

FIG. 7 depicts a perspective view of the vehicular structure, according to an embodiment of the invention as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

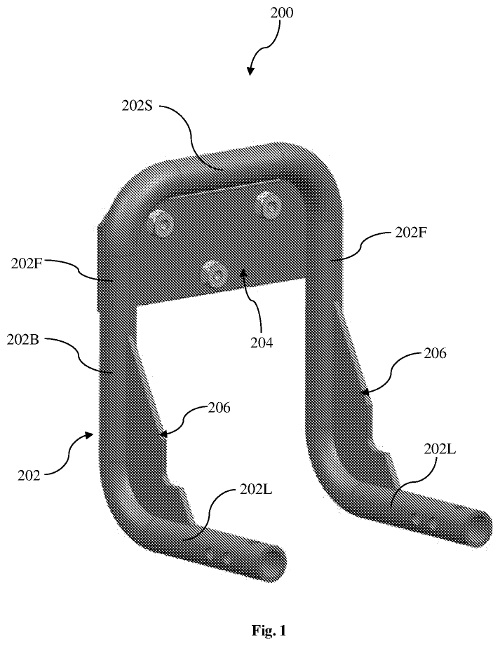

The embodiments herein achieve a front bumper assembly for a vehicle, which is removably connected to a vehicular structure at at least one of a first position and a second position. Referring now to the drawings, and more particularly to FIGS. 1 through 7, where similar reference characters denote corresponding features consistently throughout the figures, there are shown embodiments.

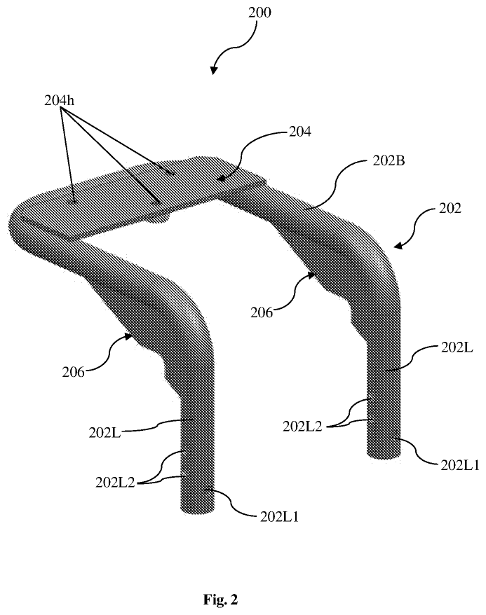

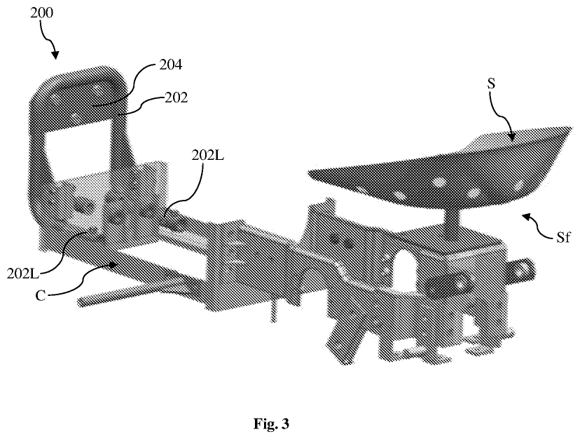

FIG. 1 depicts a perspective view of a front bumper assembly 200 for a vehicle, according to an embodiment of the invention as disclosed herein. FIG. 2 depicts another perspective view of the front bumper assembly 200, according to an embodiment of the invention as disclosed herein. In an embodiment, the front bumper assembly 200 is removably connected to a vehicular structure C (as shown in FIG. 3 to FIG. 7) at at least one of a first position and a second position. It is also within the scope of the invention to indirectly and removably connect the front bumper assembly 200 to the vehicular structure C at at least one of the first position and the second position. In an embodiment, the front bumper assembly 200 is used for removably mounting at least one of an operator's seat S (as shown in FIG. 3 to FIG. 6), a ballast means, and an add-on structure thereon when the front bumper assembly 200 is in the second position. It is also within the scope of the invention to configure the front bumper assembly 200 to removably receive any other means or any miscellaneous thing thereon at the second position. In an embodiment, the front bumper assembly 200 includes a bumper frame 202, a mounting member 204 and a plurality of reinforcement members 206. For the purpose of this description and ease of understanding, the front bumper assembly 200 is explained herein below with reference to be provided in an agricultural vehicle. However, it is also within the scope of the invention to implement/practice the front bumper assembly 200 in an off-road vehicle and any other type of vehicle without otherwise deterring the intended function of the front bumper assembly 200 as can be deduced from the description and corresponding drawings.

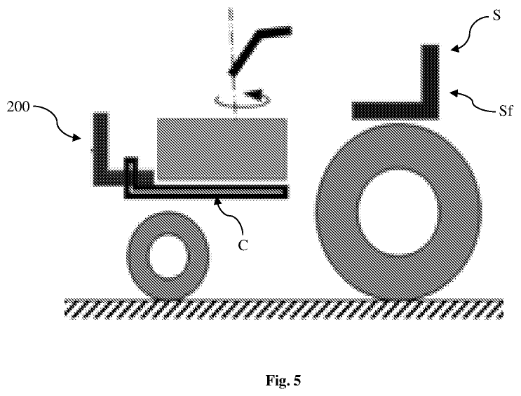

The first position of the front bumper assembly 200 is defined as “a plurality of legs 202L (as shown in FIG. 3) of the bumper frame 202 is horizontally and removably connected to the vehicular structure C”. The first position of the front bumper assembly 200 enables the front bumper assembly 200 to deform therein to absorb impact energy in an event of frontal impact (low speed collision) between the vehicle and another vehicle or fixed object to protect an engine (not shown) and the front-end components of the vehicle, where the vehicle is being operated from a first driving position in which the operator's seat S (as shown in FIG. 3 and FIG. 5) is provided at a first seating position Sf (as shown in FIG. 3 and FIG. 5) which is at a rear end of the vehicle, and in between and above the rear wheels of the vehicle. It is also within the scope of the invention to configure the front bumper assembly 200 to protect the engine (not shown) and the front-end components of the vehicle irrespective of the position of the front bumper assembly 200. Further, it is also within the scope of the invention to removably attach any of bumper beams and any other energy absorbing structure to the front end of the front bumper assembly 200 to absorb the impact energy.

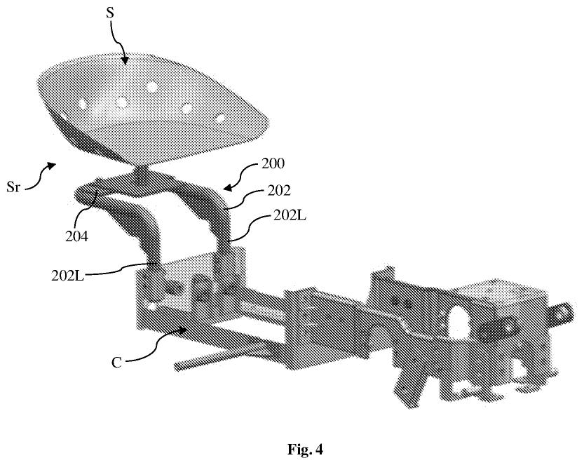

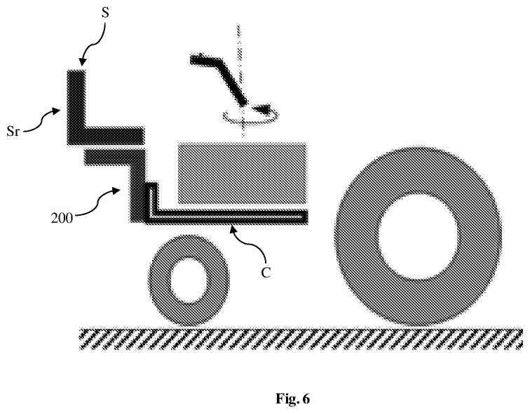

The second position of the front bumper assembly 200 is defined as “the plurality of legs 202L (as shown in FIG. 4) of the bumper frame 202 is vertically and removably connected to the vehicular structure C”. The second position of the front bumper assembly 200 enables removable mounting of at least one of the operator's seat S, the ballast means and the add-on structure thereon. The mounting of the operator's seat S onto the mounting member 204 of the front bumper assembly 200 enables an operator to be seated onto the operator's seat S (as shown in FIG. 4 and FIG. 6) and operate the vehicle from a second seating position Sr (as shown in FIG. 4 and FIG. 6) which is at a front end of the vehicle, and immediately onto the front bumper assembly 200. The mounting of the operator's seat S onto the front bumper assembly 200 enhances the visibility of the operator which in turn enhances agricultural operations and reduces efforts of the operator. The mounting of the ballast means onto the front bumper assembly 200 provides stability to the vehicle during lifting of an agricultural implement coupled to the rear end of the vehicle, and/or the vehicle is being operated in agricultural fields. The ballast means is also called as ballast weight or counterweight or balancing means. In one embodiment, the ballast means is directly and removably mounted on the front bumper assembly 200. In another embodiment, the ballast means is mounted onto the front bumper assembly 200 through the add-on structure, where the add-on structure is at least a ballast holding structure. It is also within the scope of the invention to integrate the ballast to the front bumper assembly 200 or removably mount the ballast means onto the front bumper assembly 200 through a ballast holding structure when the front bumper assembly is in the first position. The mounting of the add-on structure onto the front bumper assembly 200 enables the add-on structure to accommodate any of tools and auxiliary equipment's, devices and other accessories in the add-on structure, where the add-on structure is at least a storage compartment. It is also within the scope of the invention to accommodate any other means inside the add-on structure (storage compartment). The mounting of the add-on structure the front bumper assembly 200 enables the add-on structure to mount at least one of agricultural devices, spare wheels, machines, mechanical devices such as pumps and generator onto the front bumper assembly 200, where the ad-on structure is at least a mounting structure. It is also within the scope of the invention to removably mount any other structures or means onto the front bumper assembly 200 through the add-on structure (mounting structure).

In an embodiment, the bumper frame 202 includes a base frame 202B and a plurality of legs 202L. The base frame 202B defines one part of the bumper frame 202 and the plurality of legs 202L defines another part of the bumper frame 202. The base frame 202B is also called as first frame. The base frame 202B of the bumper frame 202 includes a plurality of first portions 202F and at least one second portion 202S.

Each first portion 202F of the base frame 202B are provided at a predetermined distance from the other and is parallel to the other. Each first portion 202F of the base frame 202B of the front bumper frame 202 is a vertical tubular portion and a horizontal tubular portion when the front bumper assembly 200 is in the first position and the second position respectively. Each first portion 202F of the base frame 202B has a circular cross-section. It is also within the scope of the invention to provide each first portion 202F of the base frame 202B in any other cross-section.

The second portion 202S of the base frame 202B extends between the first portions 202F along a width wise direction of the vehicle at a predetermined position. The second portion 202S of the base frame 202B is a tubular cross portion. It is also within the scope of the invention to provide a plurality of second portions extending between the first portions 202F and accordingly the mounting member 204 or any other mounting arrangement for mounting at least one of the operator's seat S, the ballast means and the add-on structure can be provided. The second portion 202S of the base frame 202Bhas a circular cross-section. It is also within the scope of the invention to provide the second portion 202S of the base frame 202B in any other cross-section.

In an embodiment, a reference plane of the base frame 202B of the bumper frame 202 is substantially transverse to a horizontal plane of the vehicle when the front bumper assembly 200 is in the first position. In an embodiment, the reference plane of the base frame 202B of the bumper frame 202 is at least one of co-planar and parallel to the horizontal plane of the vehicle when the front bumper assembly 200 is in the second position. The base frame 202B of the bumper frame 202 substantially defines a U-shaped configuration. It is also within the scope of the invention to provide the base frame 202B of the bumper frame 202 in any other shape and size. It is also within the scope of the invention to provide a solid base frame (202B) for the bumper frame 202. Furthermore, it is also within the scope of the invention to provide foams or energy absorbing means or any other means inside the base frame 202B of the bumper frame 202 to absorb the impact energy during collision.

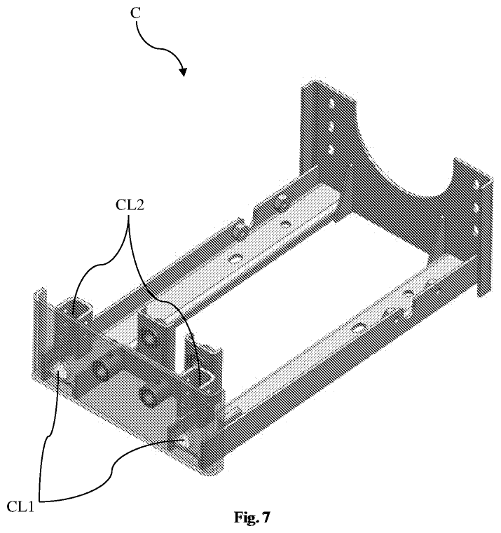

Each leg 202L of the bumper frame 202 is transversely extending from corresponding each first portion 202F of the base frame 202B and provided at a predetermined distance from the other. It is also within the scope of the invention to provide each leg 202L to the bumper frame 202 to extend from any other portion of the base frame 202B of the bumper frame 202. Each leg 202L is parallel to the other. In the first position of the front bumper assembly 200, each leg 202L of the bumper frame 202 is received by corresponding bumper frame leg receiving portion CL1 (as shown in FIG. 7) of the vehicular structure C to horizontally and removably connect each leg 202L of the bumper frame 202 to the vehicular structure C thereby removably connecting the front bumper assembly 200 to the vehicular structure C. Each leg 202L of the bumper frame 202B is a horizontal tubular portion when the front bumper assembly 200 is in the first position. It is also within the scope of the invention to provide each leg 202L of the bumper frame 202 as a solid section instead of tubular section. Each leg 202L of the bumper frame 202B defines at least one first locking member receiving portion 202L1 (as shown in FIG. 2) adapted to receive corresponding locking elements (not shown) therein to secure the front bumper assembly 200 to the vehicular structure C at the first position. The first locking member receiving portion 202L1 of each leg 202L is at least an opening (through hole) and each locking element (not shown) that is received by corresponding first locking member receiving portion 202L1 of each leg 202L is at least one of a fastener and a locking pin. In the second position of the front bumper assembly 200, each leg 202F of the bumper frame 202 is received by corresponding another bumper frame leg receiving portion CL2 (as shown in FIG. 7) of the vehicular structure C to vertically and removably connect each leg 202L of the bumper frame 202 to the vehicular structure C thereby removably connecting the front bumper assembly 200 to the vehicular structure C Each leg 202L of the bumper frame 202B is a vertical tubular portion when the front bumper assembly 200 is in the second position. Each leg 202L of the bumper frame 202B defines a plurality of second locking member receiving portion 202L2 (as shown in FIG. 2) adapted to receive corresponding another locking element (not shown) therein to secure the front bumper assembly 200 to the vehicular structure C at the second position. Each second locking member receiving portion 202L2 of each leg 202L is at least an opening (through hole) and each locking element (not shown) that is received by corresponding each locking member receiving portions 202L2 of each leg 202L is at least one of a fastener and a locking pin. Each leg 202L of the bumper frame 202B has a circular cross-section. It is also within the scope of the invention to provide each leg 202L of the bumper frame 202B in any other cross-section.

The mounting member 204 is connected to each first portion 202F of the base frame 202B along the widthwise direction of the vehicle at a predetermined position. The mounting member 204 is adapted to facilitate removable mounting of at least one of the operator's seat S, the ballast means and the add-on structure thereon to the front bumper assembly 200 when the front bumper assembly 200 is in the second position. The mounting member 204 of the front bumper assembly 200 is adapted to removably receive the operator's seat S at the second seating position Sr corresponding to the second driving position in the vehicle when the front bumper assembly 200 is in the second position, where the second seating position Sr is opposite to the first seating position Sf. The mounting member 204 defines a plurality of openings 204h (as shown in FIG. 2) adapted to receive corresponding plurality of locking elements (not shown) therein to secure at least of the operator seat S, the ballast means and the add-on structure onto the mounting member 204 of the front bumper assembly 200 when the front bumper assembly 200 is in the second position. Each locking element (not shown) received by corresponding each opening 204h of the mounting member 204 is at least one of a fastener and a locking pin. It is also within the scope of the invention to provide more than one mounting member (204) to be connected to the base frame 202B of the bumper frame 202. The mounting member 204 is at least one of a mounting plate and a mounting bracket. It is also within the scope of the invention to eliminate the mounting member (204) and provide plurality of second portions (202S) to the base frame 202B to facilitate mounting of at least one of the operator's seat S, the ballast means and the add-on structure thereon when the front bumper assembly 200 is in the second position.

The plurality of reinforcement members 206 is adapted to reinforce the bumper frame 206. Each reinforcement member 206 is also called as stiffener member. Each reinforcement member 206 is connected to corresponding first portion 202F of the base frame 202B and corresponding each leg 202L of the bumper frame 202.

The first position of the front bumper assembly 200 substantially defines a L-shape configuration. The second position of the front bumper assembly 200 substantially defines an inverted L-shape configuration. However, it is also within the scope of the invention to provide the front bumper assembly 200 in any other shape and size without otherwise deterring the intended function of the front bumper assembly 200 as can be deduced from the description and corresponding drawings. Further, it is also within the scope of the invention to provide the front bumper assembly 200 with a solid bumper having a L-shape configuration, where the solid bumper includes a first portion (first solid section) and a second portion (second solid section) transversely extending from the first portion (first solid section), wherein the first portion and the second portion of the solid bumper forms the L-shape configuration.

FIG. 7 depicts a perspective view of the vehicular structure C, according to an embodiment of the invention as disclosed herein. The vehicular structure C defines a plurality of bumper frame leg receiving portion CL1 and a plurality of another bumper leg receiving portion CL2. Each bumper frame leg receiving portion CL1 of the vehicular structure C is used to receive corresponding each leg 202L of the bumper frame 202 to horizontally and removably connect each leg 202L of said bumper frame 202 to the vehicular structure C at the first position. Each bumper frame leg receiving portion CL1 of the vehicular structure C is at least one of an opening and a cavity. Each another bumper frame leg receiving portion CL2 of the vehicular structure C is used to receive corresponding each leg 202L of the bumper frame 202 to vertically and removably connect each leg 202L of said bumper frame 202 to the vehicular structure C at the second position. Each bumper frame leg receiving portion CL2 of the vehicular structure C is at least one of a vertical elongated opening and a vertical elongated cavity. The vehicular structure C is at least a chassis frame C.

Therefore, a front bumper assembly 200 which is removably connected to a vehicular structure C at at least one of a first position, and a second position is provided for a vehicle.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

We claim:

1. A front bumper assembly 200 for a vehicle, said front bumper assembly 200 comprising:
a bumper frame 202 having a base frame 202B and a plurality of legs 202L,
wherein
said front bumper assembly 200 is adapted to be removably connected to a vehicular structure C at a first position in which each leg 202L of said bumper frame 202 is horizontally connected to the vehicular structure C, and a second position in which each leg 202L of said bumper frame 202 is vertically connected to the vehicular structure C.

2. The front bumper assembly 200 as claimed in claim 1, wherein the base frame 202B of said bumper frame 202 defines,
a plurality of first portions 202F, wherein each first portion 202F is provided at a predetermined distance from the other; and
at least one second portion 202S adapted to extend between each first portion 202F along a widthwise direction of the vehicle.

3. The front bumper assembly 200 as claimed in claim 2, wherein each leg 202L of said bumper frame 202 is adapted to transversely extend from corresponding first portion 202F of the base frame 202B and provided at a predetermined distance from the other.

4. The front bumper assembly 200 as claimed in claim 3, wherein each leg 202L of said bumper frame 202 is received by corresponding each bumper frame leg receiving portion CL1 of the vehicular structure C to horizontally connect each leg 202L of said bumper frame 202 to the vehicular structure C at the first position.

5. The front bumper assembly 200 as claimed in claim 4, wherein each said leg 202F of said bumper frame 202 is received by corresponding each another bumper frame leg receiving portion CL2 of the vehicular structure C to vertically connect each leg 202L of said bumper frame 202 to the vehicular structure C at the second position.

6. The front bumper assembly 200 as claimed in claim 5, wherein a reference plane of the base frame 202B of said bumper frame 202 is substantially transverse to a horizontal plane of the vehicle when said front bumper assembly 200 is in the first position.

7. The front bumper assembly 200 as claimed in claim 6, wherein the reference plane of the base frame 202B of said bumper frame 202 is at least one of co-planar and parallel to the horizontal plane of the vehicle when said front bumper assembly 200 is in the second position.

8. The front bumper assembly 200 as claimed in claim 2, wherein each first portion 202F of the base frame 202B of said bumper frame 202 is a vertical tubular portion and a horizontal tubular portion when said front bumper assembly 200 is in the first position and the second position respectively, where each first portion 202F is parallel to the other.

9. The front bumper assembly 200 as claimed in claim 3, wherein each leg 202L of said bumper frame 202B is a horizontal tubular portion and a vertical tubular portion when said front bumper assembly 200 is in the first position and the second position respectively, where each leg 202L is parallel to the other.

10. The front bumper assembly 200 as claimed in claim 9, wherein the second portion 202S of the base frame 202B of said bumper frame 202 is a tubular cross portion.

11. The front bumper assembly 200 as claimed in claim 1, wherein an operator's seat S is provided at a first seating position Sf corresponding to a first driving position in the vehicle when said front bumper assembly 200 is at least at the first position.

12. The front bumper assembly 200 as claimed in claim 11 comprises at least one mounting member 204 adapted to be connected to the base frame 202B of said bumper frame 202 along the widthwise direction of the vehicle.

13. The front bumper assembly 200 as claimed in claim 12, wherein said mounting member 204 of said front bumper assembly 200 is adapted to removably receive an operator's seat S at a second seating position Sr corresponding to a second driving position in the vehicle when said front bumper assembly 200 is in the second position, where the second seating position Sr is opposite to the first seating position Sf.

14. The front bumper assembly 200 as claimed in claim 13, wherein said mounting member 204 of said front bumper assembly 200 is adapted to mount at least one of a ballast means and an add-on structure when said front bumper assembly 200 is in the second position.

15. The front bumper assembly 200 as claimed in claim 14, wherein mounting of the add-on structure onto said mounting member 204 of said front bumper assembly 200 at the second position enables the add-on structure to mount at least one of agricultural devices, machines, spare wheels, mechanical devices such as pumps and generator, onto said mounting member 204 of said front bumper assembly 200, where the add-on structure is at least a mounting structure.

16. The front bumper assembly 200 as claimed in claim 14, wherein mounting of the add-on structure onto said mounting member 204 of said front bumper assembly 200 at the second position enables the add-on structure to accommodate any of tools and auxiliary equipment's in the add-on structure, where the add-on structure is at least a storage compartment.

17. The front bumper assembly 200 as claimed in claim 1 comprises a plurality of reinforcement members 206 adapted to reinforce said bumper frame 202.

18. The front bumper assembly 200 as claimed in claim 1, wherein the first position of said front bumper assembly 200 substantially defines a L-shape configuration,
wherein the second position of said front bumper assembly 200 defines an inverted L-shape configuration.
